(19) United States
(12) Patent Application Publication
(10) Pub. No.: US 2011/0304830 A1
(43) Pub. Date: Dec. 15, 2011

(54) COLOR WHEEL, MANUFACTURING METHOD OF THE COLOR WHEEL, AND PROJECTOR INCLUDING THE COLOR WHEEL

(75) Inventors: Hideki KATO, Kitasaku-gun (JP); Atsushi KITAMURA, Kitasaku-gun (JP)

(73) Assignee: MINEBEA CO., LTD., Kitasaku-gun (JP)

(21) Appl. No.: 13/117,773

(22) Filed: May 27, 2011

(30) Foreign Application Priority Data
Jun. 9, 2010 (JP) 2010-132009

(51) Int. Cl. G03B 21/14; G01J 3/52

(52) U.S. Cl. 353/84; 264/1.1

(57) ABSTRACT

There is provided a manufacturing method of a color wheel for a projector. The method includes contacting a phosphor layer contour correcting device on a surface of a color wheel substrate, the phosphor layer contour correcting device having a concavity to form a space that patterns a desired phosphor layer contour, the length of which is constant in a radial direction; injecting phosphor additive resin into the space that is composed of a surface of the color wheel substrate and the concavity of the phosphor layer contour correcting device; maintaining the phosphor additive resin in the space; and heating the phosphor additive resin.

### BACKGROUND OF THE INVENTION

1. Field of the Invention

The present invention relates to a color wheel for a projector that projects and enlarges a display image by means of a projection optical system so as to obtain a large display image, and the manufacturing method of the color wheel. The present invention also relates to a projector that includes the color wheel in its projection optical system.

2. Description of the Related Art

A projector (a projection-type image display device) used in home theaters, presentations, etc. in which to magnify and project displayed images by means of a projection optical system so as to obtain large-screen displayed images has been commercialized. This type of projector displays, while applying light that is projected from a light source as an illuminant, images on a screen through an electro-optical device using a spatial optical modulator such as a digital micromirror device or a liquid crystal display device. The projector may use a high-pressure mercury vapor lamp or a xenon lamp as the light sources. Due to content of mercury or problems caused by calorific values, the high-pressure mercury vapor lamp or the xenon lamp appears to be not appropriate. Accordingly, in recent years a projector applying a light emitting diode (LED) or a laser has been developed.

For example, as the projector using the LED and the laser, a projector manufactured by Casio Computer Co., Ltd. has been exhibited at the International CES (Consumer Electronics Show), the trade show of consumer electronics, held in the United States in 2010. Here, an LED is used for a red illuminant; a blue laser is used for a blue illuminant; and what the phase and the wavelength of a blue laser is converted is used for a green illuminant (this type of projector is hereinafter called as the “hybrid type”). Further, in this type of projector, a color wheel as the time-sharing type of a filter device that rotates at a high speed has been generally applied (see Japanese Patent Application Laid-Open No. 2009-277516 and Japanese Patent Application Laid-Open No. 2004-341105).

In a color composite method regarding the above hybrid type projector, FIG. 8 shows the schematic diagram thereof. In FIG. 8, a projector 100 has the following components as the projection optical system: a blue illuminant 1, a red illuminant 2, a color wheel 5, dichroic mirrors 3, 8, lenses 4, 9, mirrors 6, 7, a digital micromirror device 10 as a spatial optical modulator, a projection optical system 11, and a screen 12. Blue light (B) emitted from the blue illuminant 1 to which a blue laser emitter is applied is irradiated on the color wheel 5 after passing through the dichroic mirror 3 and the lens 4 that the blue light permeates. As shown in FIGS. 9A and 9B, the color wheel 5 has a metal circular substrate 501 with a cutout. The surface of the circular substrate 501 is then divided into a portion 502 on which a phosphor layer that emits green light (G) (hereinafter referred to as the “green phosphor”) is formed, and a portion 503 where the green phosphor is not provided, The blue light passes through the portion (cutout portion) 503 where the green phosphor is not provided, and permeates the dichroic mirror 8. The blue light is then condensed by the lens 9 and finally reaches to the digital micromirror device 10.

A partial blue light (BR) that has been reflected from the color wheel 5 goes back to the side of the blue illuminant 1. When the blue light is irradiated on the green phosphor, the green light is to be emitted. This green light is then passed through the lens 4 and reflected by the dichroic mirror 3, which reflects the green light. The green light is then reflected by the mirrors 6, 7 and the dichroic mirror 8, and collected by the lens 9 so as to reach to the digital micromirror device 10.

In addition, red light (R) emitted from the red illuminant 2 to which red LED is applied passes through the dichroic mirror 3 and is reflected by the mirrors 6, 7 and the dichroic mirror 8. The red light (R) is then collected by the lens 9 and reaches to the digital micromirror device 10. In three primary colors of the blue light (B), the green light (G) and the red light (R) that are introduced into the digital micromirror device 10, their incident lights are converted in synchronization so that the three primary colors are processed in time series to produce images of each own color. The images are then projected on the screen 12 through the projection optical system 11. Here, the rotation control of the color wheel 5 or the control of light passing through the color wheel 5 is a conventional technology. Explanation thereof is thus omitted.

Here, considering the above-described hybrid type projector where the color wheel 5 is included in its projection optical system, in order to optimize the chromaticity of projected images, it would be preferable to minimize the occurrence of non-uniform chromaticity of the green light (G) that is reflected by the portion 502 on which the green phosphor layer is formed. On the other hand, since the green phosphor generates heat by which the blue laser light is received, it would be preferable that the component (hereinafter referred to as the “phosphor additive resin”) of the green phosphor layer is resin having high heat resistance and superior light permeability. The phosphor additive resin is generally coated on the glass-made circular substrate 501 by means of dispenser or printing methods. In case that the viscosity of the phosphor additive resin is low after being coated on the circular substrate 501, as shown in FIG. 9B, the phosphor additive resin tends to spread on the surface of the circular substrate 501 whereby the thickness thereof becomes uneven. When making the thickness of the phosphor additive resin become uneven, the thickness of phosphors becomes non-uniform, becoming one cause of making the adjustment of its chromaticity difficult. To overcome the above problem, for example, resin with high viscosity (or resin enhancing its thixotrophy) may be used. With this, it can reduce the spread of resin after being coated on the substrate; however, in general, since the resin having high heat resistance and superior light permeability has low viscosity, it will cause a problem that the durability of a color wheel is deteriorated.

### SUMMARY OF THE INVENTION

The present invention has been made in light of the above problems, and it is an object of the present invention to provide a color wheel for a projector capable of preventing the occurrence of irregular colors while maintaining its durability. Further, another object of the present invention is to improve the chromaticity of a projector that includes a color wheel in its projection optical system such as a hybrid type projector.

Embodiments according to the present invention hereinbelow exemplify some structures of the present invention, and are itemized for facilitating understanding of various structures of the present invention. Each item does not intend to limit the technical scope of the present invention. While considering the best modes to carry out the present invention, even if components of each item is partially substituted or deleted, or even if another component is added thereto, these should be regarded as the elements of the technical scope of the present invention.

In order to achieve the object described above, according to a first aspect of the present invention, there is provided a manufacturing method of a color wheel for a projector, comprising the steps of: contacting a phosphor layer contour correcting device on a surface of a color wheel substrate, the phosphor layer contour correcting device having a concavity to form a space that patterns a desired phosphor layer contour, the length of which is constant in a radial direction; injecting phosphor additive resin into the space that is composed of a surface of the color wheel substrate and the concavity of the phosphor layer contour correcting device; maintaining the phosphor additive resin in the space; and heating the phosphor additive resin.

With this manufacturing method of the color wheel, the phosphor additive resin is injected into the space formed between the surface of the color wheel substrate and the concavity of the phosphor layer contour correcting device. The phosphor additive resin, being fluid in a pre-thermosetting status, is corrected to have a desired phosphor layer configuration where its thickness is constant in a radius direction. The phosphor layer is then sealed. While maintaining the sealing condition of the phosphor layer, the phosphor additive resin is heated so as to be thermoset.

In the first aspect of the present invention, in the process of heating the phosphor additive resin, the phosphor additive resin is subjected to temporal heat; the phosphor layer contour correcting device is removed as necessary; and the phosphor additive resin that has been subjected to the temporal heat is then fully heated.

With this manufacturing method of the color wheel, in the process of heating the phosphor additive resin, by making the phosphor additive resin temporally heated at first, the phosphor additive resin is temporarily thermoset. Accordingly, the phosphor additive resin by itself is allowed to keep a desired phosphor layer configuration where the thickness thereof is constant in its radius direction. Following the step, as necessary, after the phosphor layer contour correcting device is removed, the phosphor additive resin that has been temporally thermoset is fully heated so as to completely harden the phosphor additive resin.

In the first aspect of the present invention, the phosphor layer contour correcting device is composed of: a first die having a cavity in which the color wheel substrate is positionable; and a second die that forms a counterpart relative to the first die and that has a cavity which forms a space patterning a desired phosphor layer contour on a surface of the color wheel substrate that has been positioned in the cavity of the first die.

With this manufacturing method of the color wheel, as the phosphor layer contour correcting device, the first die and the second die are applied. The color wheel substrate is then set to the first die that has the cavity in which the color wheel substrate is positionable. The second die works as a counterpart relative to the first die and has the cavity to form a space patterning the desired phosphor layer contour on the surface of the color wheel substrate positioned in the cavity of the first die. The phosphor additive resin is injected into the space that patterns the desired phosphor layer contour, the space being formed between the surface of the color wheel substrate and the cavity of the second die. The phosphor additive resin is then sealed in the space.

In the first aspect of the present invention, the following steps are taken: unclamping the first die and the second die; injecting the phosphor additive resin into the cavity of the second die while maintaining the unclamping state; covering the phosphor additive resin that has been injected into the cavity of the second die by means of the color wheel substrate; closing the first die and the second die; and heating the phosphor additive resin.

With this manufacturing method of the color wheel, in a condition where the first die and the second die are unclamped, the phosphor additive resin is injected into the cavity of the second die at first. Following the step, the phosphor additive resin that has been injected into the cavity of the second die is covered with the color wheel substrate. Then, the first die and the second die are clamped so s to position the color wheel substrate. In a condition where both the first die and the second die are clamped, the phosphor additive resin is injected into the space that patterns the desired phosphor layer contour formed between the surface of the color wheel substrate and the cavity of the second die. The phosphor additive resin is then sealed in the space.

In the first aspect of the present invention, the following steps are taken: unclamping the first die and the second die; setting the color wheel substrate in the cavity of the first die while maintaining the unclamping state; applying the phosphor additive resin on the surface of the color wheel substrate on which the phosphor layer contour is to be formed; clamping the first die and the second die; filling the phosphor additive resin in the cavity of the second die; and heating the phosphor additive resin.

With this manufacturing method of the color wheel, in a condition where the first die and the second die are unclamped, the color wheel substrate is first set to the cavity of the first die for positioning. Following the step, the phosphor additive resin is applied on the surface of the color wheel substrate along an area at which the phosphor layer contour is formed. The first die and the second die are then clamped. In a condition where the first die and the second die are clamped, the phosphor additive resin is injected into the space that patterns the desired phosphor layer contour formed between the surface of the color wheel substrate and the cavity of the second die. The phosphor additive resin is then sealed in the space.

In the first aspect of the present invention, the manufacturing method of the color wheel is satisfied with the following: 1) A non-circular substrate is applied to the color wheel substrate as that at least one segment composing the color wheel is cuttable; 2) The first die is applied to a die that has a cavity in which the non-circular substrate is positionable; 3) The second die is applied to a die that has a cavity by which at least one segment forms a space to pattern a desired phosphor layer contour on a surface of the non-circular substrate that has been positioned in the cavity of the first die; 4) The first die and the second die are clamped; 5) The phosphor additive resin on the surface of the non-circular substrate is thermoset; 6) The non-circular substrate is cut out so as to obtain at least one segment with a desired shape; and 7) The segments are combined to each other so as to form the whole color wheel.

With this manufacturing method of the color wheel, the second die with the cavity is clamped relative to the surface of a material positioned in the cavity of the first die so as to produce at least one segment, the segment forming a space that patterns the desired phosphor layer contour. The phosphor additive resin is sealed in the space so as to be corrected to have a desired phosphor layer contour where the thickness of the phosphor layer is constant in a radius direction. After the phosphor additive resin on the surface of the material is thermoset (the meaning of “being thermoset” includes hereinafter the process of “being temporally thermoset” or “being fully thermoset”), the material is cut out to have a desired segment formation. By combining the segments, the segment type of color wheel can be formed. In this case, by changing the color of the phosphor layer applied on each segment, it would be possible to obtain a color wheel that has specific different colored segments in a particular proportion, or that has different kinds of the segments. Further, it can provide another advantage that clearly defines the border of each phosphor layer in a different color.

In the first aspect of the present invention, the phosphor layer contour correcting device has, instead of the second die, a transparent substrate that has a concavity identical with the cavity of the second die, and the transparent substrate is to be left as a component when the color wheel is completed.

With this manufacturing method of the color wheel, as the phosphor layer contour correcting device, instead of the second die, the transparent substrate with a concave portion identical with the cavity of the second die is used. By clamping the first die and the transparent substrate, a space that patterns a desired phosphor layer contour is formed between the surface of the color wheel substrate and the concave portion of the transparent substrate. The phosphor additive resin is then injected into and sealed in the space. Following the step, the phosphor additive resin on the surface of the color wheel substrate is thermoset so as to obtain the color wheel where the transparent substrate is left as the component of the finished color wheel. Here, the transparent substrate may be any material as long as it has necessary transparency and heat resistance.

In the first aspect of the present invention, the phosphor layer contour correcting device has, instead of the first die, a flat holder on which the color wheel substrate is placed, the flat holder making the concavity of the transparent substrate to be opened in a direction of a side end face of the color wheel substrate when the flat holder is combined with the transparent substrate; the phosphor additive resin is injected into the side end face of the concavity of the transparent substrate; and the phosphor additive rein is thermoset.

With this manufacturing method of the color wheel, the flat holder is applied instead of the first die. The phosphor additive resin is injected from the side end face of the concavity of the transparent substrate. The phosphor additive resin is thus sent into the concavity of the transparent substrate thereby correcting the phosphor additive resin to have a desired phosphor layer contour. Here, in case that the viscosity of the phosphor additive resin is low, etc., as necessary, the phosphor additive resin is injected after sealing the side end face of the concavity of the transparent substrate. Following the step, the phosphor additive resin on the surface of the color wheel substrate is thermoset so as to obtain the color wheel where the transparent substrate is left as the component of the finished color wheel. Here, the flat holder may be any material as long as it has necessary heat resistance,

In the first aspect of the present invention, the phosphor layer contour correcting device has either a transparent substrate that has a concavity identical with the cavity of the second die or a non-transparent substrate that has a concavity identical with the transparent substrate; the phosphor additive resin is subjected to temporal heat; the transparent substrate or the non-transparent substrate is removed; and the phosphor additive resin that has been subjected to temporal heat is then fully heated.

With this manufacturing method of the color wheel, as regards the phosphor layer contour correcting device, the transparent substrate that has the concavity identical with the cavity of the second die, or the non-transparent substrate that has the concavity identical with the transparent portion is applied. By clamping the first die or the flat holder and the transparent substrate or the non-transparent substrate, the space hat patterns a predetermined phosphor layer contour is formed between the surface of the color wheel substrate and the concavity of either the transparent substrate or the non-transparent substrate. The phosphor additive resin is then injected into and sealed in the space. Following the step, the phosphor additive resin is temporally thermoset until maintaining a desired phosphor layer contour where the thickness thereof is constant in its radius direction, Then, the transparent substrate or the non-transparent substrate is removed, and the phosphor additive resin that has been temporally thermoset is fully heated. Accordingly, the phosphor additive rein is fully thermoset. Here, the non-transparent substrate may be any material as long as it has necessary heat resistance.

In the first aspect of the present invention, the phosphor layer contour correcting device has a predetermined convexoconcave configuration by which an antireflection structure is formable on a surface of the concavity.

With this manufacturing method of the color wheel, since the concave portion of the phosphor layer contour correcting device has the surface where the predetermined convexoconcave form working as the anti-reflective structure is formed, it would be possible to transfer the anti-reflective structure to the phosphor additive resin. In general, the application of AR coating for anti-reflective purpose tends to be difficult when applying to soft resin before being thermoset. However, by making the surface of the phosphor additive resin itself to have the anti-reflective structure, it becomes possible to improve application efficiencies of light.

In a second aspect of the present invention, there is provided a color wheel for a projector produced by the manufacturing method of the color wheel according to any one of the first aspects, wherein a phosphor layer, the thickness of which is constant in a radial direction of the color wheel, is formed at a predetermined area of the color wheel in its circumferential direction.

In the color wheel for a projector produced by the manufacturing method of the color wheel according to any one of the first aspects, the phosphor layer, the thickness of which is constant in a radius direction of the color wheel, is formed in a predetermined area of the color wheel in its circumferential direction. Accordingly, it would be possible to prevent the occurrence of irregular color in application of the color wheel for a projector.

In a third aspect of the present invention, there is provided a color wheel for a projector, wherein a phosphor layer, the thickness of which is constant in a radial direction of the color wheel, is formed at a predetermined area of the color wheel in its circumferential direction.

In the color wheel for a projector, since the phosphor layer, the thickness of which is constant in a radius direction of the color wheel, is formed in a predetermined area of the color wheel in its circumferential direction, it would be possible to prevent the occurrence of irregular color in the color wheel for a projector.

In a fourth aspect of the present invention, there is provided a projector comprising in its projection optical system: a light source; a lens and the color wheel recited in the second aspect and the third aspect.

The projector of the above comprises the color wheel for a projector in its projection optical system, the color wheel being formed as that the phosphor layer, the thickness of which is constant in a radius direction of the color wheel, is formed in a predetermined area of the color wheel in its circumferential direction. Accordingly, it would be possible to prevent the occurrence of irregular color in the color wheel for a projector so as to improve the chromaticity of images projected on a projector.

Since the present invention is structured as discussed hereinabove, it makes possible to provide a color wheel where durability of the color wheel for a projector is not deteriorated while occurrence of irregular color can be prevented. Further, the present invention can surely contribute to improvement of chromaticity of a projector where a color wheel is included in its projection optical system such as the hybrid type projector, etc.

### BRIEF DESCRIPTION OF THE DRAWINGS

FIG. 1 is an explanatory view of the manufacturing method of a color wheel according to the first embodiment of the present invention where FIG IA is a sectional view showing that a first die and a second die are clamped each other, and FIG. 1B is a plan view of the color wheel;

FIG. 2 is an explanatory view of the manufacturing method of a color wheel according to the second embodiment of the present invention where FIG. 2A is a sectional view showing that a first die and a second die are clamped each other, and FIG. 2B is a plan view of the color wheel;

FIG. 3 is an explanatory view of the manufacturing method of a color wheel according to the third embodiment of the present invention where FIG. 3A is a sectional view showing that a first die and a second die are clamped each other; FIG. 3B is a plan view where phosphor additive resin on the surface of a non-circular substrate is thermoset; and

FIG. 3C is a plan view of the color wheel;

FIG. 4 is a sectional view of the manufacturing method of a color wheel according to the fourth embodiment of the present invention showing that a transparent substrate and a flat holder are clamped each other;

FIG. 5 is an explanatory view of the manufacturing method of a color wheel according to the fifth embodiment of the present invention where FIGS. 5A to SC show the manufacturing procedure of forming convexoconcave working as an anti-reflective structure on phosphor additive resin of the color wheel, and FIGS. 5D to 5F exemplify kinds of the convexoconcave;

FIGS. 6A to 6F are explanatory drawings in relation with some optical features of the color wheel for a projector according to the embodiments of the present invention;

FIGS. 7A to 7F are explanatory drawings in relation with some optical features of the color wheel for a projector according to the embodiments of the present invention;

FIG. 8 is the conventional schematic drawing of a hybrid-type projector; and

FIG. 9A is a schematic plan diagram showing a conventional color wheel for a projector, and FIG. 9B is the side view thereof where phosphor additive resin is applied on the color wheel as that the thickness of the phosphor additive resin is not uniform in the radius direction of the color wheel.

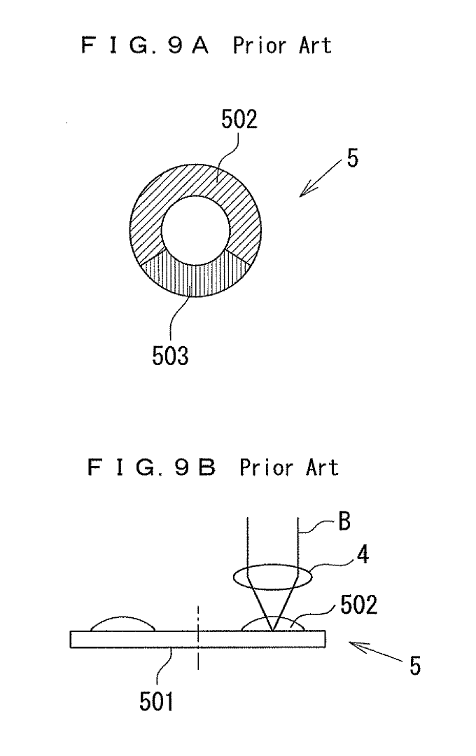

### DETAILED DESCRIPTION OF THE PREFERRED EMBODIMENTS

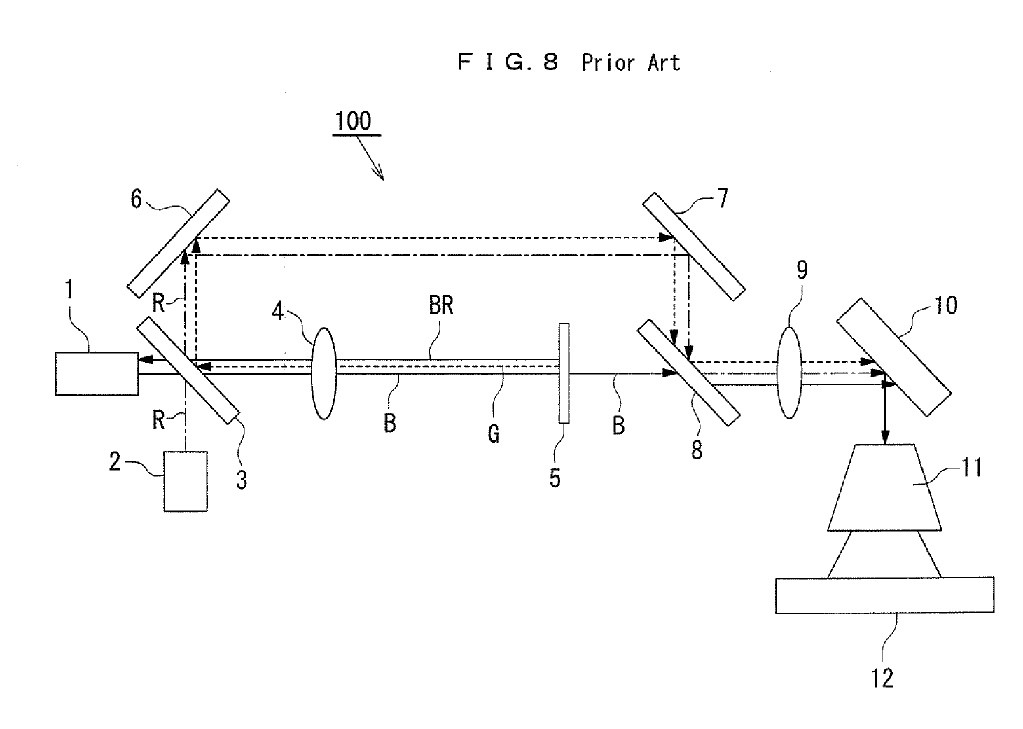

Embodiments of the present invention will be explained with reference to the accompanying drawings. Hereinbelow, any part that is identical with or correspondent to the conventional art will be indicated with the same reference, and the detail explanation thereof will be omitted. Further, noted that a color wheel for a projector according to embodiments of the present invention is applicable to a hybrid-type projector as exemplified in FIG. 8. Accordingly, the detail explanation of the projector as a whole should be referred to FIG. 8.

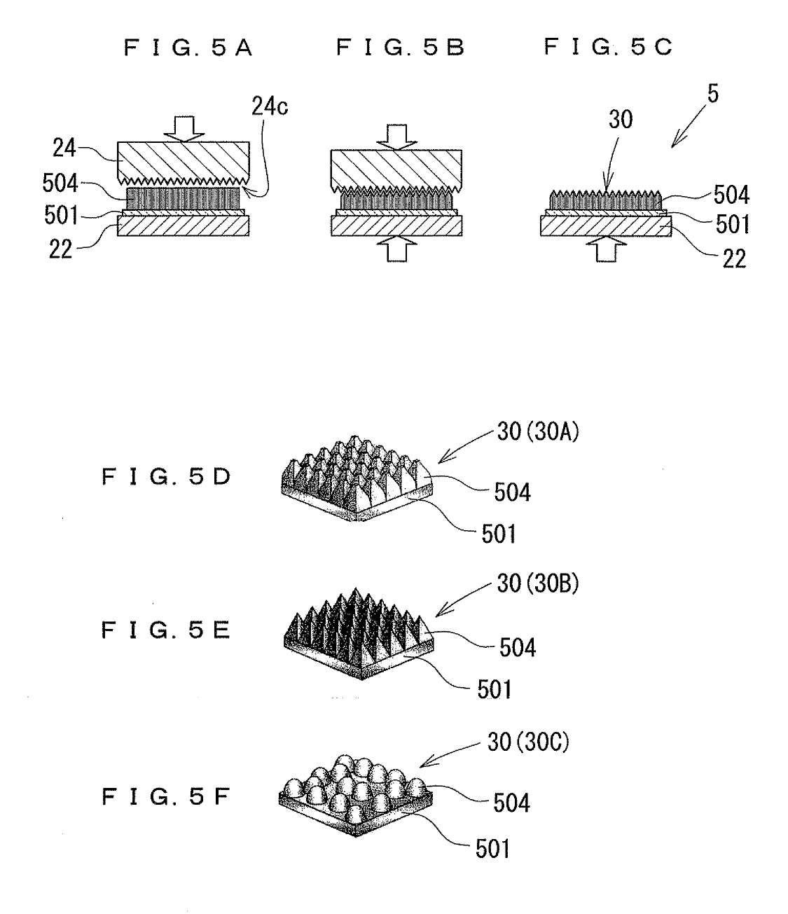

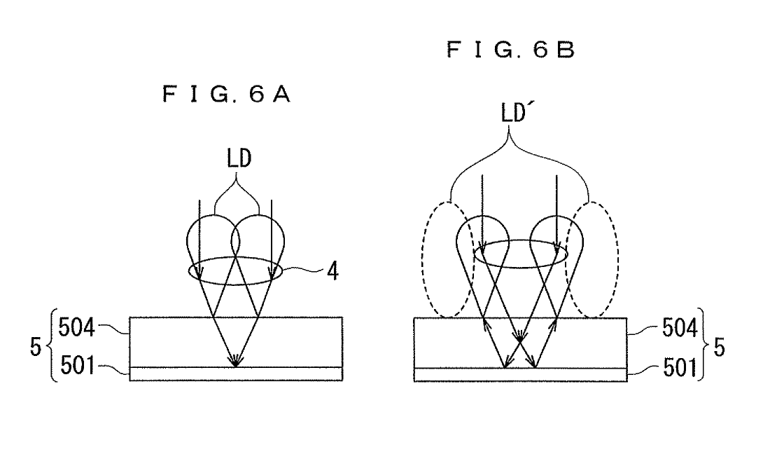

Here, a color wheel substrate 501 composing a color wheel 5 (including a non-circular substrate 511 in FIG. 3) is made of glass; however, the material is not limited to glass. For example, as explained in the conventional art, when a reflective optical system is applied, the material may be metal. Further, phosphor material applied to a phosphor layer 504 may be the following. For example, as phosphor for a green illuminant, the following may be named: Zn₂SiO₄: Mn, BaAl₁₂O₁₉: Mn, BaMgAl₁₄O₂₃: Mn, SrAl₁₂O₁₉: Mn, ZnAl₁₂O₁₉: Mn, CaAl₁₂O₁₉: Mn, YBO₃: Tb, LuBO₃: Tb, GdBO₃: Tb, ScBO₃: Tb, Sr₄Si₃O₈Cl₄: Eu. Furthermore, as phosphor for a red illuminant, the following may be named: Y₂O₃: Eu, Y₂SiO₅: Eu, Y₃Al₅O₁₂: Eu, Zn₃ (PO₄)₂: Mn, YBO₃: Eu, (Y, Gd) BO₃: Eu, GdBO₃: Eu, ScBO₃: Eu, LuBO₃: Eu.

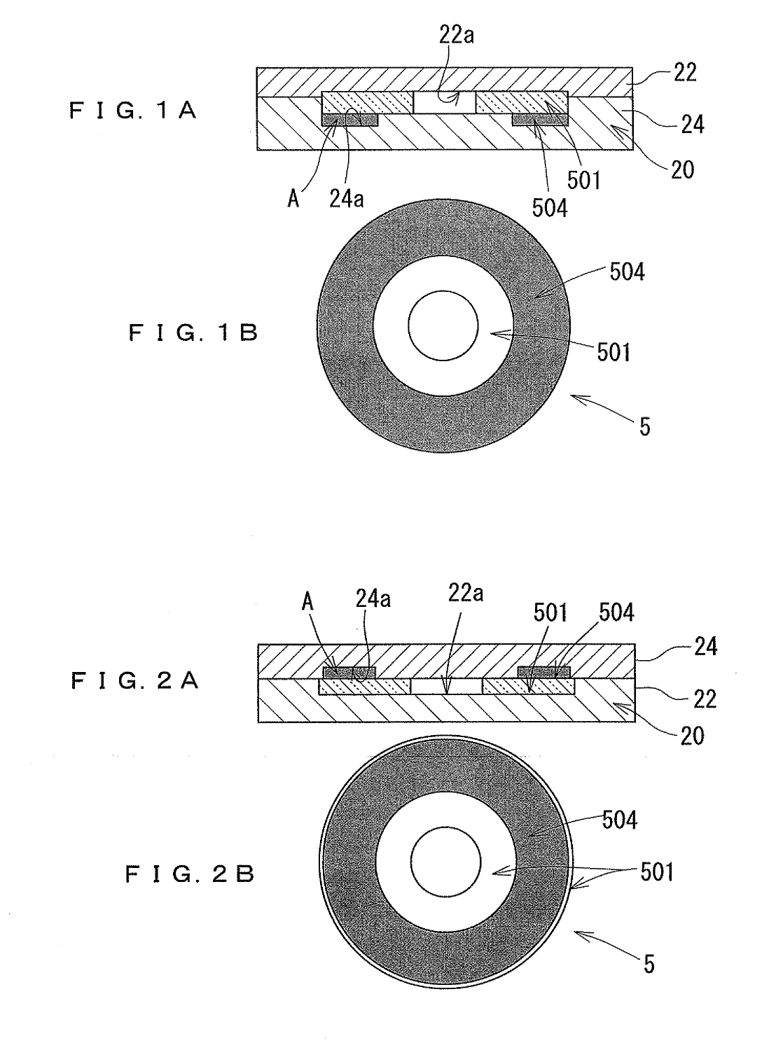

First, the manufacturing method of a color wheel for a projector according to the first embodiment of the present invention will be explained. Schematically, as shown in FIG. 1A, a phosphor layer contour correcting device 20 is employed, the phosphor layer contour connecting device 20 having a concavity by which a space A is formable on the surface of the color wheel substrate 501. A desired phosphor layer contour, the thickness of which is constant in the radius direction of the color wheel substrate 501, can be thus obtained. Phosphor additive resin 504 is then injected into and sealed in the space A formed between the surface of the color wheel substrate 501 and the concavity of the phosphor layer contour correcting device 20. In this condition, the phosphor additive resin 504 is heated. Here, the phosphor additive resin 504 may be first temporarily heated by, for example, a heater built-in the phosphor layer contour correcting device 20. Then, as necessary, after the phosphor layer contour correcting device 20 has been removed, the phosphor additive resin 504 that has been temporarily thermoset is introduced into a furnace, etc. so as to be fully thermoset. Through these processes, the color wheel 5 as shown in FIG. 1B can be obtained.

More specifically, as the phosphor layer contour correcting device 20, the following dies are applied: a first die 22 that has a cavity 22a in which the color wheel substrate 501 is positionable; and a second die 24 that forms a counterpart relative to the first die 22 and that has a cavity 24a which forms the space A patterning a desired phosphor layer contour on the surface of the color wheel substrate 501 that has been positioned in the cavity of the first die 22.

FIG. 1 exemplifies a case that the first die 22 is an upper die while the second die 24 is a lower die. The color wheel 501 has a circular opening at its center so as to be in an annular configuration. In a condition where the first die 22 and the second die 24 are unclamped, the phosphor additive resin 504 is injected into the cavity 24a of the second die 24. The phosphor additive resin 504 that has been injected into the cavity 24a of the second die 24 is then covered by the color wheel substrate 501. Following the step, the first die 22 and the second die 24 are clamped as shown in FIG. 1A, and the phosphor additive resin 504 is heated. Here, the first die 22 exemplified in FIG. I has the concave cavity 22a for which the color wheel substrate 501 is positioned; however, if the cavity 24a of the second die 24 allows the color wheel substrate 510 to be securely positioned, it would be possible that the portion of the first die 22 to which the color wheel substrate 510 is abutted may be flat (meaning that the depth of the cavity 22a is zero).

According to the first embodiment of the present invention that has the above constitution, the following operational effects are obtainable. That is, by injecting the phosphor additive resin 504 into the space A formed between the surface of the color wheel substrate 501 and the concavity of the phosphor layer contour correcting device 20, the phosphor additive resin 504, being fluid in a pre-thermosetting status, is corrected to have a desired phosphor layer contour, the thickness of which is constant in the radius direction of the color wheel substrate 501. The phosphor additive resin 504 is then sealed. Here, although detail is explained hereinafter, the constant thickness of the phosphor additive resin 504 is corrected to be the minimum. While being sealed, the phosphor additive resin 504 is temporarily thermoset. Accordingly, the phosphor additive resin 504 by itself is adapted to keep a desired phosphor layer configuration where its thickness in a radius direction is constant. After the phosphor layer contour correcting device 20 is removed, the phosphor additive resin 504 that has been temporarily thermoset is fully heated to achieve a fully thermosetting state.

As the phosphor layer contour correcting device 20, the first die 22 and the second die 24 are applied. The color wheel substrate 501 is set in the cavity 22a of the first die 22. The surface of the color wheel substrate 501 that has been set to the first die 22 and the cavity 24a of the second die 24 will form the space A patterning a predetermined phosphor layer configuration. The phosphor additive resin 504 is then injected into and sealed in the space A. Here, the second die 24 is a counterpart relative to the first die 22 and has the cavity 24a which forms the space A patterning a predetermined phosphor layer configuration on the surface of the color wheel substrate 501 that has been positioned in the cavity 22a of the first die 22.

In this case, in a condition that the first die 22 and the second die 24 are unclamped, the phosphor additive rein 504 is first injected into the cavity 24a of the second die 24. Then, the phosphor additive resin 504 that has been injected into the cavity 24a of the second die 24 is covered by the color wheel substrate 501. Following the step, the first die 22 and the second die 24 are clamped. The color wheel 501 is positioned by the cavity 22a of the first die 22. While being clamped, the phosphor additive rein 504 is injected into and sealed in the space A patterning a desired phosphor layer configuration that is formed by the surface of the color wheel substrate 501 and the cavity 24a of the second die 24. Finally, as shown in FIG. 1B, the color wheel 5 for a projector can be obtained. In the color wheel 5, the phosphor additive resin 504, the thickness of which is constant in the radius direction of the color wheel 501, is formed at a predetermined area of the color wheel 501 in its circumferential direction (all-rounded area in case of FIGS.).

In case of the first embodiment of the present invention, when using the phosphor additive resin 504 that has relatively high viscosity, contrary to the case of FIG. 1, the first die 22 may be a lower die while the second die 24 may be an upper die. Specifically, in a condition that the first die 22 and the second die 24 are unclamped, the color wheel 501 is set to the cavity 22a of the first die 22. The phosphor additive resin 504 is then injected into the cavity 24a of the second die 24. Following the step, the first die 22 and the second die 24 are clamped. By injecting the phosphor additive resin 504 into the cavity 24a of the second die 24 and by heating the phosphor additive resin 504, it would be possible to obtain operational effects identical with the above case.

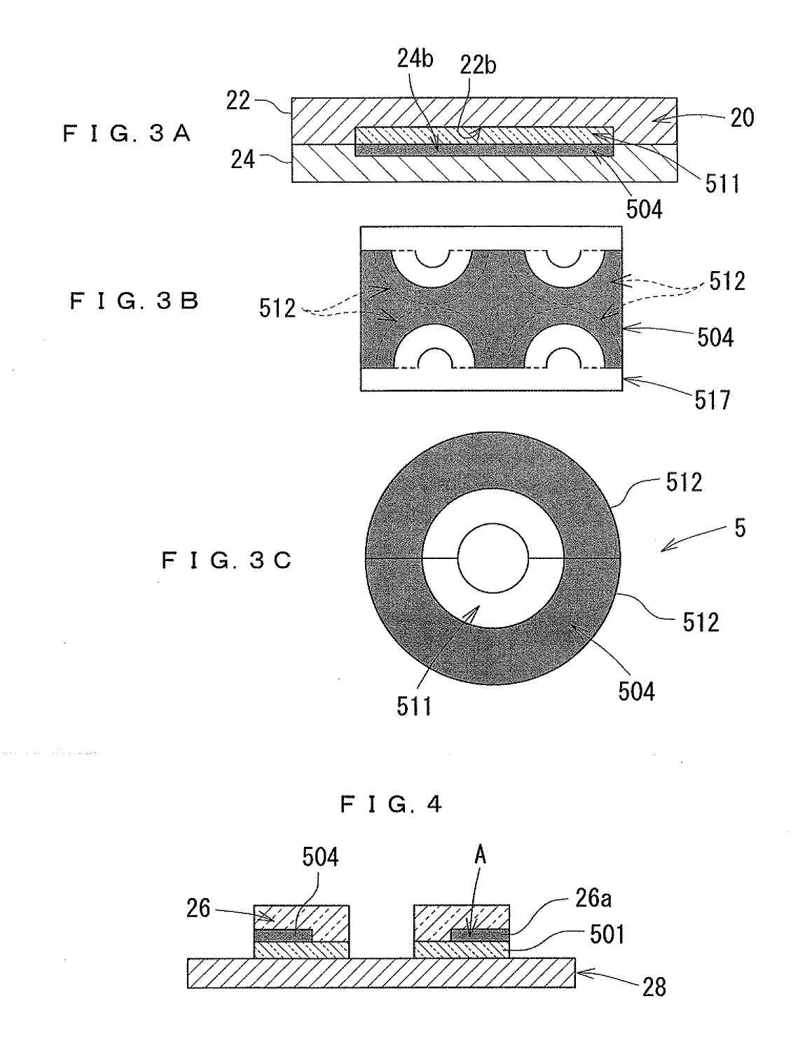

Next, with reference to FIG. 2, the second embodiment of the present invention will be hereinafter explained. Here, parts identical with the prior art or the first embodiment of the present invention will be indicated with the same referential number, and the detail explanation thereof will be omitted.

In the second embodiment of the present invention, the first die 22 is a lower die, and the second die 24 is an upper die. In a condition where the first die 22 and the second die 24 are unclamped, the color wheel substrate 501 is set to the cavity 22a of the first die 22. The phosphor additive resin 504 is applied by means of appropriate methods on the surface of the color wheel substrate 501 on which a predetermined phosphor layer configuration should be formed. When applying the phosphor additive resin 504, its viscosity should be considered. Following the step, the first die 22 and the second die 24 are clamped. The phosphor additive resin 504 is then filled in the cavity 24a of the second die 24. The phosphor additive resin 504 is subsequently heated. In the second embodiment, as shown in FIG. 2, the second die 24 is intentionally abutted to the upper face of the peripheral end portion of the color wheel substrate 501 whereby the layer of the phosphor additive resin 504 is formed to stay slightly inside than the outer peripheral end of the color wheel substrate 501 in a radius direction. With this constitution, even if a space is generated between the color wheel substrate 501 and the second die 24 due to difference in thermal expansion or dimensional accuracy therebetween, it makes possible to prevent the phosphor additive resin 504 having low viscosity from going round toward the backside of the color wheel substrate 501 where resin should not be applied.

In the second embodiment of the present invention, in a condition where the first die 22 and the second die 24 are unclamped, the color wheel 501 is first set to the cavity 22a of the first die 22 for positioning. Next, the phosphor additive resin 504 is applied on the surface of the color wheel substrate 501 on which the phosphor layer configuration should be formed. The first die 22 and the second die 24 are then clamped. While being in the clamped condition, the phosphor additive resin 504 is sealed in the space A patterning a predetermined phosphor layer configuration that is formed between the surface of the color wheel substrate 501 and the cavity 24a of the second die 24. With the above steps, it would be possible to obtain operational effects that are the same with the first embodiment. Further, as shown in FIG. 2B, the color wheel 5 for a projector can be obtained. In the color wheel for a piston 5, the phosphor additive resin 504, the thickness of which is constant in the radius direction of the color wheel 501, is formed at a predetermined area of the color wheel 501 in its circumferential direction (all-rounded area in case of FIGS.). Here, the other operation effects identical with the first embodiments of the present invention will be omitted in its detail.

Next, with reference to FIG. 3, the third embodiment of the present invention is explained hereinafter. Here, portions identical with the prior art, the first embodiment or the second embodiment are indicated with the same referential numbers, and the detail explanation thereof is omitted.

In the third embodiment of the present invention, the non-circular substrate 511 is employed for the color wheel substrate. As exemplified in FIG. 3, the non-circular substrate 511 is formed into a rectangle. At least one piece of segment 512 composing the color wheel 5 can be cut out from the non-circular substrate 511. The segment 512 shown in FIG. 3 is formed into a semi-circle) (180°) whereby the complete color wheel 5 is formable by two pieces of the segments 512. However, as necessary, the segment 512 may be further divided. As the first die 22, a die having a cavity 22b in which the non-circular substrate 511 is positioned is used. Further, as the second die 24, a die having a cavity 24b is used. Here, the cavity 24b of the die forms a space patterning a desired phosphor layer configuration for at least one segment 512 on the surface of the non-circular substrate 511 positioned in the cavity 22b of the first die 22. The first die 22 and the second die 24 are clamped. After the phosphor additive resin 504 is thermoset on the surface of the non-circular substrate 511, the segment 512 having a desired form is cut out. By combining the plurality of segments 512, the color wheel 5 in a segment type can be thus formed as shown in FIG. 3C. Here, after the phosphor additive resin 504 is circularly applied on the non-circular substrate 511 and is thermoset, one piece of the color wheel 5 in a circular shape (that is, a monolithic type) is cut out.

In the manufacturing method of the color wheel according to the third embodiment of the present invention, a vertical arrangement between the first die 22 and the second die 24, the configuration of the non-circular substrate 511, timing in which the phosphor additive resin 504 is injected, etc. are all optionally selectable from the procedures that have been explained in case of the first or the second embodiment. For example, the following manufacturing step may be taken. That is, the color wheel substrate is set to the cavity of the first die for positioning. Then, the phosphor additive resin 504 is injected into the cavity of the second die. Next, the first die and the second die are clamped. Lastly, the phosphor additive resin 504 is sealed in a space patterning a desired phosphor layer configuration, the space being formed by the surface of the color wheel substrate and the cavity of second die. Further, by changing the color of the phosphor additive resin 504 (or the phosphor layer) for each of the segments 512, it would be possible to obtain the color wheel 5 that has specific different colored segments in a particular proportion, or that has different kinds of the segments. Here, it can further provide another advantage of clearly defining the border of each phosphor layer in different colors. The detail explanation of operational effects identical with the first and the second embodiments will be omitted.

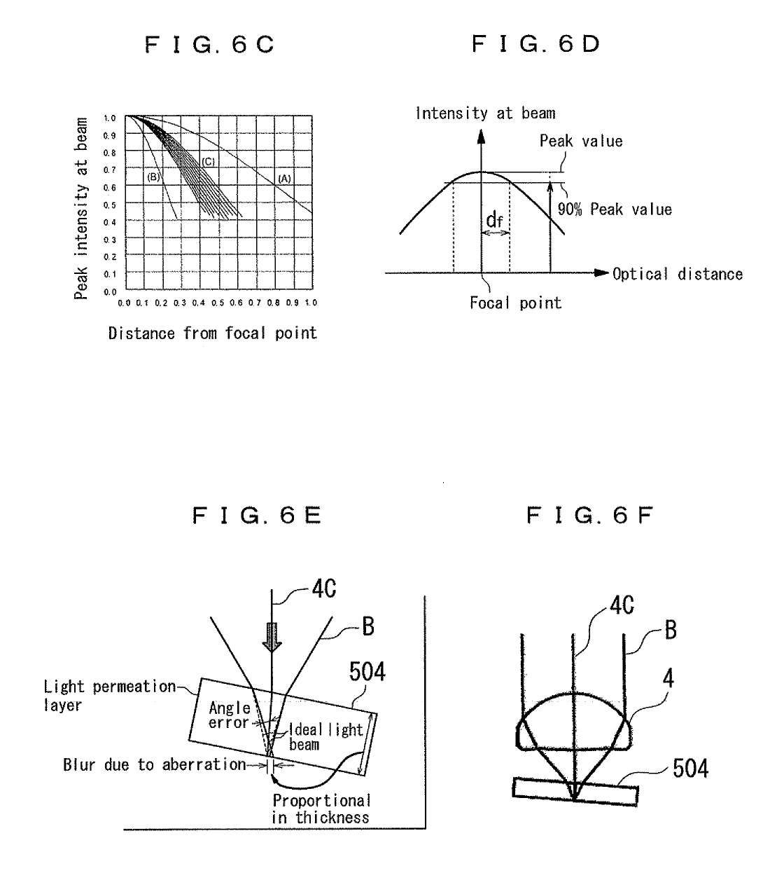

Next, with reference to FIG. 4, the fourth embodiment of the present invention will be described hereinbelow. Here, portions identical with the prior art and the first to the fourth embodiments will be indicated with the same referential number, and the detail explanation thereof is omitted.

In the fourth embodiment of the present invention, as the phosphor layer contour correcting device 20, instead of the second die 24 that has been applied in the first to the third embodiments, a transparent substrate 26 that has a concave portion 26a identical with the cavity 24a (24b) of the second die 24 is applied. Further, instead of the first die 22, a flat holder 28 is applied. On the flat holder 28, the color wheel substrate 501 (511) is placed. In a condition where the flat holder 28 is combined with the transparent substrate 26, the concavity 26a of the transparent substrate 26 is adapted to open in the side end face direction of the color wheel substrate 501 (511).

The phosphor additive resin 504 is sealed in a space A patterning a desired phosphor layer configuration that is formed between the surface of the color wheel substrate 501 (511) and the concavity 26a of the transparent substrate 26. Here, in case that the viscosity of the phosphor additive resin 504 is low, the side end face of the concavity of the transparent substrate may be sealed as necessary with a detachable circular cover, etc. when the phosphor additive resin 504 is injected. This can prevent the phosphor additive resin 504 from excessively traveling toward the side end face of the color wheel substrate 501 (511). Then, the phosphor additive resin 504 on the surface of the color wheel substrate 501 (511) is thermoset so as to obtain the color wheel 5 where the transparent substrate 26 is left as a component of the finished color wheel.

Moreover, in the fourth embodiment of the present invention, by using a mold release agent and the like, the transparent substrate 26 may be removed without being left as a component of the finished color wheel. In this case, the transparent substrate 26 may be any non-transparent material. Further, without using the flat holder 28, the first die 22 as shown in FIGS. 1 to 3 may be used in combination with the transparent substrate 26. Here, since it is preferable that the component of the transparent substrate 26 has a superior optical feature and high heat resistance, glass or polycarbonate, etc. is suitable. On the other hand, non-transparent substrates will be satisfied as long as they have high heat resistance. Accordingly, glass, polyamideimide resin (PAI resin), PBT resin, fluororesin, phenol resin, epoxy resin, etc. may be said as suitable (since they have heat resistance). The flat holder may be any material as long as it has necessary heat resistance. Detail explanation of other operational effects identical with the first to the third embodiments of the present invention will be omitted here.

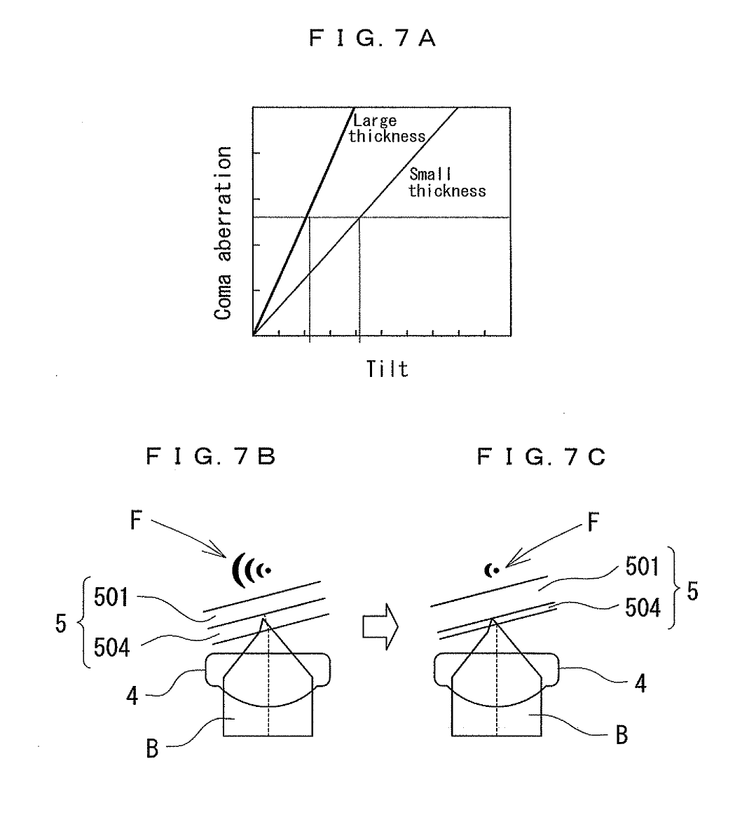

Next, with reference to FIG. 5, the fifth embodiment of the present invention will be explained hereinafter. Here, portions identical with the prior art and the first to the fourth embodiments of the present invention will be indicated with the same referential number, and the detail explanation thereof will be omitted here.

In the fifth embodiment of the present invention, as shown in FIG. 5A, the cavity of the second die 24 has a surface on which a convexoconcave configuration 24c is formed. This convexoconcave configuration 24c has a shape that forms an antireflection structure 30 each shown from FIG. 5D to FIG. 5F. The convexoconcave configuration 24c transfers a predetermined convexoconcave forms on the surface of the phosphor additive rein 504 so as to constitute the surface of the phosphor additive resin 504 by itself to have an antireflection structure. Here, FIG. 5D to FIG. 5F exemplify the configuration of the antireflection structure 30. The antireflection structure 30A where the wall of its square pyramid is structured by a curved surface while the upper end portion of the square pyramid is made flat has the lowest reflective ratio and has a wide conical aperture. The antireflective ratio will be lowered in order of an antireflection structure 30B with a simple square pyramid and an antireflection structure 30C with a dome configuration.

In general, it is difficult to apply an anti-reflection treatment coating (AR coating) on a prethermosetting soft resin. In the fifth embodiment of the present invention, however, since the surface of the phosphor additive resin 504 by itself has the antireflection structure 30, it makes possible to improve the application efficiency of light. Detail explanation of other operational effects identical with the first to the fourth embodiments of the present invention will be omitted here.

As discussed hereinabove, according to the first to the fifth embodiments of the present invention, irrespective of the viscosity of the phosphor additive resin 504, it would be possible to manufacture the color wheel 5 for a projector where a phosphor layer, the thickness of which is constant in the radius direction of the color wheel 5, is formed at a predetermined area of the color wheel 5 in its circumferential direction. Accordingly, irregular color generated on the color wheel 5 for a projector becomes preventable. Further, since occurrence of the irregular color in a projector where the color wheel 5 for a projector is included in its projection optical system can be prevented, chromaticity of images projected by the projector is improved.

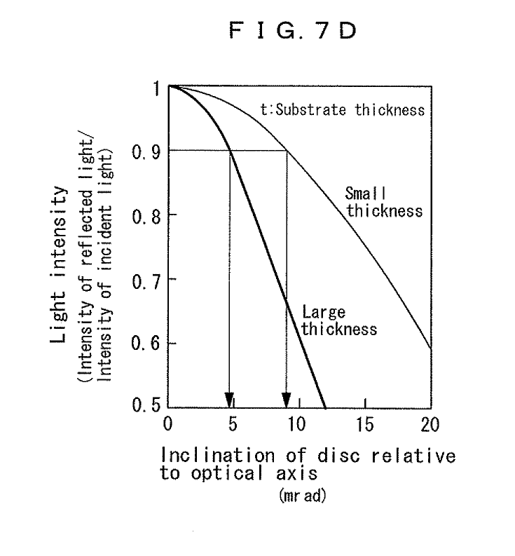

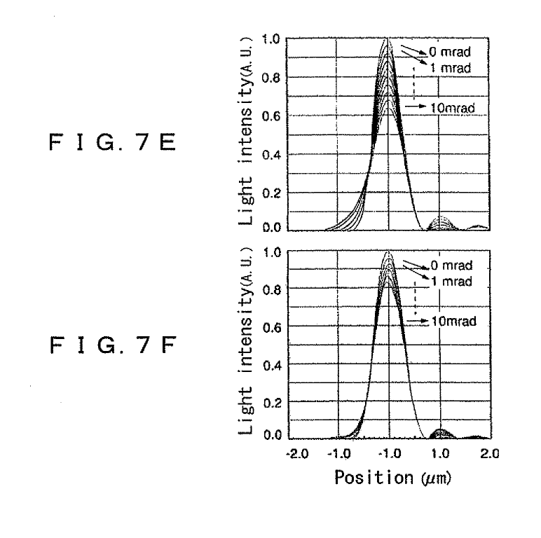

Hereinbelow, with reference to FIGS. 6 and 7, effects of the embodiments of the present invention will be explained.

According to the embodiments of the present invention, not only is it possible to provide the color wheel 5 for a projector where the phosphor additive resin 504 has superior surface smoothness, but it is also able to make the layer of the phosphor additive resin 504 to be as thin as possible (for example, 0.6 mm or less) by using the phosphor layer contour correcting device 20 such as the first die 22, the second die 24, etc. Further, even if the viscosity of the phosphor additive resin 504 is low, it is still possible to obtain the same effects discussed hereinabove.

In addition, by making the thickness of the layer of the phosphor additive resin 504 to be as thin as possible, the following effect becomes attainable. First, in case that the layer of the phosphor additive resin 504 is constant, and, for example, a blue light B output form the blue illuminant 1 (see FIG. 8) passes through the lens 4 and is irradiated in focus on the color wheel substrate 5, as shown in FIG. 6, light reflected from the color wheel substrate 501 can go back to the lens 4 even though a so-called Lambert Distribution (LD) is indicated.

Here, however, if the blue light B is not correctly focused on the color wheel 501, as shown in FIG. 6B, a partial reflective light in the Lambert Distribution LD′ fails to go back to the lens 4. Also, in case that a focus distance is not matched, peak intensity will be deteriorated as shown in FIGS. 6C and 6D.

Furthermore, as shown in FIGS. 6E and 6F, in case that the surface of the layer of the phosphor additive resin 504 is inclined, and the relative inclined angle of the surface of the phosphor additive resin 504 relative to the optical axis 4C of the lens 4 becomes large, as shown in FIGS. 7A to 7C, a so-called coma aberration F is generated so as to deform a light spot. Since the coma aberration F can be determined by the following Formula (1), it can be said that making the thickness t of a disc to be thin will become advantageous to reduce the occurrence of the coma aberration F.

W={x·(n²−1)·n²·NA³·cos(tilt)·sin (tilt)·t}/{(n²−sin²(tilt))^{5/2}·λ} FORMULA (1)

Here, n is a refractive index; NA is a numerical aperture; t is the thickness of a disc; λ is a laser wavelength; λ is a coefficient; tilt is (R²+T²)^{1/2}; R is a radial skew; and T is a tangential skew.

According to the above relation, as shown in FIGS. 7D to 7F, the thinner the thickness of the layer of the phosphor additive resin 504 becomes, the larger the tolerant level of an optical intensity becomes relative to the relative inclined angle of the surface of the phosphor additive resin 504 to the optical axis 4C of the lens 4. Thus, according to the embodiments of the present invention, by making the layer of the phosphor additive resin 504 to be as thin as possible, it becomes possible to enlarge the optical intensity that is reflected by the color wheel 5 for a projector.

1. A manufacturing method of a color wheel for a projector, comprising the steps of:
contacting a phosphor layer contour correcting device on a surface of a color wheel substrate, the phosphor layer contour correcting device having a concavity to form a space that patterns a desired phosphor layer contour, the length of which is constant in a radial direction;
injecting phosphor additive resin into the space that is composed of a surface of the color wheel substrate and the concavity of the phosphor layer contour correcting device;
maintaining the phosphor additive resin in the space; and
heating the phosphor additive resin.

2. The manufacturing method of the color wheel for a projector according to claim 1, wherein in the process of heating the phosphor additive resin, the phosphor additive resin is subjected to temporal heat; the phosphor layer contour correcting device is removed as necessary;
and the phosphor additive resin that has been subjected to the temporal heat is then fully heated.

3. The manufacturing method of the color wheel for a projector according to claim 1, wherein the phosphor layer contour correcting device is composed of: a first die having a cavity in which the color wheel substrate is positionable; and a second die that forms a counterpart relative to the first die and that has a cavity which forms a space patterning a desired phosphor layer contour on a surface of the color wheel substrate that has been positioned in the cavity of the first die.

4. The manufacturing method of the color wheel for a projector according to claim 3, wherein the following steps are taken:
unclamping the first die and the second die;
injecting the phosphor additive resin into the cavity of the second die while maintaining the unclamping state;
covering the phosphor additive resin that has been injected into the cavity of the second die by means of the color wheel substrate;
clamping the first die and the second die; and
heating the phosphor additive resin.

5. The manufacturing method of the color wheel for a projector according to claim 3, wherein the following steps are taken:
unclamping the first die and the second die;
setting the color wheel substrate in the cavity of the first die while maintaining the unclamping state;
applying the phosphor additive resin on the surface of the color wheel substrate on which the phosphor layer contour is to be formed;
clamping the first die and the second die;
filling the phosphor additive resin in the cavity of the second die; and
heating the phosphor additive resin.

6. The manufacturing method of the color wheel for a projector according to claim 3, wherein the manufacturing method of the color wheel is satisfied with the following:
1) A non-circular substrate is applied to the color wheel substrate as that at least one segment composing the color wheel is cuttable;
2) The first die is applied to a die that has a cavity in which the non-circular substrate is positionable;
3) The second die is applied to a die that has a cavity by which at least one segment forms a space to pattern a desired phosphor layer contour on a surface of the non-circular substrate that has been positioned in the cavity of the first die;
4) The first die and the second die are clamped;
5) The phosphor additive resin on the surface of the non-circular substrate is thermoset;
6) The non-circular substrate is cut out so as to obtain at least one segment with a desired shape; and
7) The segments are combined to each other so as to form the whole color wheel.

7. The manufacturing method of the color wheel according to claim 3, wherein the phosphor layer contour correcting device has, instead of the second die, a transparent substrate that has a concavity identical with the cavity of the second die, and the transparent substrate is to be left as a component when the color wheel is completed.

8. The manufacturing method of the color wheel for a projector according to claim 7, wherein the phosphor layer contour correcting device has, instead of the first die, a flat holder on which the color wheel substrate is placed, the flat holder making the concavity of the transparent substrate to be opened in a direction of a side end face of the color wheel substrate when the flat holder is combined with the transparent substrate; the phosphor additive resin is injected into the side end face of the concavity of the transparent substrate; and the phosphor additive rein is thermoset.

9. The manufacturing method of the color wheel for a projector claim 7, wherein the phosphor layer contour correcting device has either a transparent substrate that has a concavity identical with the cavity of the second die or a non-transparent substrate that has a concavity identical with the transparent substrate; the phosphor additive resin is subjected to temporal heat; the transparent substrate or the non-transparent substrate is removed; and the phosphor additive resin that has been subjected to temporal heat is then fully heated.

10. The manufacturing method of the color wheel for a projector according to claim 1, wherein the phosphor layer contour correcting device has a predetermined convexoconcave configuration by which an antireflection structure is formable on a surface of the concavity.

11. A color wheel for a projector produced by the manufacturing method of the color wheel for a projector according to claim 1, wherein a phosphor layer, the thickness of which is constant in a radial direction of the color wheel, is formed at a predetermined area of the color wheel in its circumferential direction.

12. A color wheel for a projector, wherein a phosphor layer, the thickness of which is constant in a radial direction of the color wheel, is formed at a predetermined area of the color wheel in its circumferential direction.

13. A projector comprising in its projection optical system: a light source; a lens and the color wheel recited in claim 11.
